(19) United States
(12) Patent Application Publication
(10) Pub. No.: US 2009/0117326 A1
(43) Pub. Date: May 7, 2009

(54) Multi-piece panels for siding system

(76) Inventor: Robert Hendricks, Youngstown, OH (US)

Correspondence Address: LEV INTELLECTUAL PROPERTY CONSULTING, 4766 MICHIGAN BOULEVARD, YOUNGSTOWN, OH, 44505, US

(21) Appl. No.: 12/288,208

(22) Filed: Oct. 17, 2008

Related U.S. Application Data
(60) Provisional application No. 60/999,344, filed on Oct. 17, 2007.
(60) Provisional application No. 61/127,542, filed on May 14, 2008.

(51) Int. Cl. B32B 3/24; B32B 3/30; E04F 13/09

(52) U.S. Cl. 428/139; 52/762; 52/311.1; 52/309.1

(57) ABSTRACT

A siding system using multi-piece panels to provide a great deal of variety and flexibility, thereby facilitating a much easier and less expensive mounting process. Each of the panels is constituted by a template layer which forms at least one aperture. A protruding piece is sized and configured to fit into the aperture and be connected thereto. The protruding piece simulates natural building materials such as brick, stone, wood and the like. A wide number of different aperture sizes are available as well as a wide variety of different sizes, colors and textures for the protruding pieces that will fit therein.

### PRIORITY INFORMATION

This application relies for priority upon the following Provisional Patent Applications:
60/999,344, Filed Oct. 17, 2007
60/000,067, Filed Oct. 23, 2007
61/127,542, Filed May 14, 2008
   making reference thereto and incorporating them in their entirety.

### FIELD OF INVENTION

The present invention relates generally to the field of decorative siding panels. In particular, the present invention is directed to a system for assembling and mounting plastic siding panels in a wide variety of geometric esthetic configurations.

### BACKGROUND ART

Various types of siding materials have been used to protect and decorate the walls of structures, especially structures for which appearance and esthetics are important. Examples are natural building materials such as brick, stone, marble, plaster and wood. These have been traditionally used as structural or protective elements, often constituting the support basis of a building. In more recent times such siding has been used as a protective agent for the structure, insulation, and as decoration. The inherent beauty and traditional connotations of natural siding products have made them highly desirable for the decoration of many structures, even when not providing structural capability or protection.

Part of the esthetic appeal of these materials is the variation in appearance. For example, no two pieces of brick, stone, marble or wood are exactly alike. This adds to the decorative appeal and uses of such materials.

The natural characteristics of these materials also include certain inherent engineering limitations that preclude many structural uses. As a result natural materials such as wood, brick, stone and marble have long been superseded as structural elements in many types of construction. There are also substantial limitations in the protective and insulating qualities of those materials. The expense of large amounts of such materials would also preclude their use as thermal insulators or weather-proofing. The extremely high cost of high-quality batches of these materials (such as Italian marble, teak, ceramics and the like) keep these materials from being affordable for most structures, for almost any purpose.

Consequently, there have been numerous attempts to simulate these natural products (brick, stone, marble or wood) by using cheaper materials processed to appear as the high-quality, natural materials. Traditional examples have included plaster, stucco, drywall, woven fabrics, plywood, plastic and wooden veneers. Unfortunately, this approach requires a series of tradeoffs between the expense of extensive processing the cheaper materials and the similarity in appearance of the processed products to high-grade, natural materials. Further, certain physical requirements, outside of appearance, are necessary for the substitute materials. For example, weatherproof characteristics are necessary for exterior siding while fireproof characteristics are necessary for interior panels. Any kind of insulating characteristic is also considered highly desirable. Assuring these characteristics adds to the expense of processing the cheaper materials.

Brick and wood are the materials most often simulated. The appearance of both can be used in exterior and interior applications. However, in many situations, the appearance of stone is considered more appropriate than either brick or wood. Panels that appear to be stone structures have applications, both in exterior and interior situations, and so are very popular.

Natural stone walls can be made of regular stone pieces or irregular stone pieces, which is more common. Even if the shape of each stone piece is regular, there will be different colors and textures for each piece when dealing with natural stone. Artificial panels that simulate natural stone should also follow this pattern. Unfortunately, differences in color, texture, size and shape, while occurring naturally, are often difficult to simulate with artificial panel materials such as plastic. Normally, non-uniformity between plastic panels requires variations in the forming or molding tools, a very expensive arrangement since each variation requires different tooling for each different plastic panel.

One example is found in U.S. Pat. No. 6,237,294 to Rygiel. This patent is directed to flexible, decorative panels which simulate the appearance of stone work. The panel is composed of a flexible building sheet reinforced with light, fibrous material, and fabricated by filling a mold. These molds are constituted in a pattern simulating that of natural stonework. A fluid hardening material is placed in the mold and the overlay of reinforcing material and the flexible building sheet are arranged thereupon. While the system of Rygiel is relatively inexpensive, it is awkward to use. The poured molding is a slow and very cumbersome industrial arrangement. The only advantage is that the molds can be relatively inexpensive. Nonetheless, changing them to provide variations in the simulated stone pattern can be difficult. Further, since all the material applied to the mold is of the same type and same color, the natural variation of mixed stone work is impossible with the Rygiel system. Also, the final product of this system is very often too flexible and cumbersome to be used in many siding or panel applications. Insulation, unless embodied in the molded material, is problematic.

While a number of materials and processes can be used to simulate natural stone work, injection-molded plastic has developed into a favored option. This type of product offers a wide range of benefits. Some of these include ease of mass production, a convenient selection of sizes based upon construction industry standards, and configurations of product to facilitate convenient shipping and handling.

A wide variety of other materials and processes have been used to simulate natural stonework construction. Rygiel is simply one such example, and incorporated herein by reference. However, each of them has substantial drawbacks in comparison to the use of injection-molded panels.

Unfortunately, the advantages of injection-molded panels also lead to certain disadvantages. In particular, the plastic that is formed so easily and efficiently is monochromatic within each panel. As a result, the natural variation of colors that is found with natural stonework is impossible to simulate without expensive post molding, painting, or other additional industrial procedures. However, these additional processes would negate some of the advantages of the inexpensive basic injection molding process for producing the panels.

There are further complications inherent to using plastic injection molding when simulating a wide range of surface variations, such as that necessary for simulating natural stone work. The tooling becomes more varied, and thus, more complicated and expensive. Consequently, in conventional use, each panel looks exactly the same in terms of the stone pattern, even if the color is changed later with paint. This strongly mitigates against the simulation of a natural stone appearance. Uniformity in shape and texture is seldom a normal characteristic of natural stone construction.

Accordingly, there is substantial need for improvement in the art of simulating natural stonework (and other natural surfaces such as wood, marble, brick, or even plaster) for building siding applications. Such improvement should be adaptable to both interior and exterior uses with products that are easy to transport and handle. Above all, the products should have the appearance of natural materials, including all the variations required by the esthetics that prompt the use of such materials.

### SUMMARY OF INVENTION

It is a primary object of the present invention to provide a siding system that better simulates certain natural materials than conventional siding and panel systems.

Another object of the present invention is to provide a paneling system simulating natural materials wherein a wide variety of different colors and configurations are readily obtainable within each panel.

A further object of the present invention is to provide a paneling system simulating natural materials wherein selection of configuration and color can be effected at the time of installation.

An additional object of the present invention is to provide a siding system, simulating natural materials, that is easy to handle and transport.

It is still another object of the present invention to provide a paneling system that can be used for both interior and exterior applications.

It is yet a further object of the present invention to provide paneling system that simulates a wide variety of different natural building product appearances without requiring substantial manufacturing modifications, retooling, or post-manufacturing finishing.

It is again an additional object of the present invention to provide a paneling system, simulating natural products, in which individual panels can easily be varied in color or texture within each individual panel without expensive reprocessing or painting.

Yet another object of the present invention is to provide a multi-piece siding system in which individual panels can be substantially varied in the field without manufacturing modifications.

It is still an additional object of the present invention to provide for a wide variety of the multi-piece siding system panels, while maintaining the advantages the plastic injection molding manufacturing process.

It is yet a further object of the present invention to provide a system for multi-piece siding panels which are easily fitted and adapted to existing structures.

It is still another object of the present invention to provide a multi-panel siding system that can be easily used in relatively small packages.

It is again a further object of the present invention to provide a multi-piece siding system that admits to mass production while still permitting a wide variety of configurations.

It is still an additional object of the present invention to provide a multi-piece siding system that can be easily assembled and installed without skilled labor.

It is again a further object of the present invention to provide a siding system that accurately simulates natural surfaces using a wide variety of light building materials.

These and other goals and objects of the present invention are achieved by a siding system having at least one multi-piece panel. This panel includes a template layer having at least one aperture surrounded by a border. At least one separate, attachable protruding piece is configured to fit in the one aperture, extending above the border layer.

### BRIEF DESCRIPTION OF DRAWINGS

FIG. 1 is a top view of a typical panel in accordance with the present invention.

FIG. 2 is a side view of a typical protruding simulated “stone” piece designed to fit in the open spaces of FIG. 1.

### DETAILED DESCRIPTION OF PREFERRED EMBODIMENTS

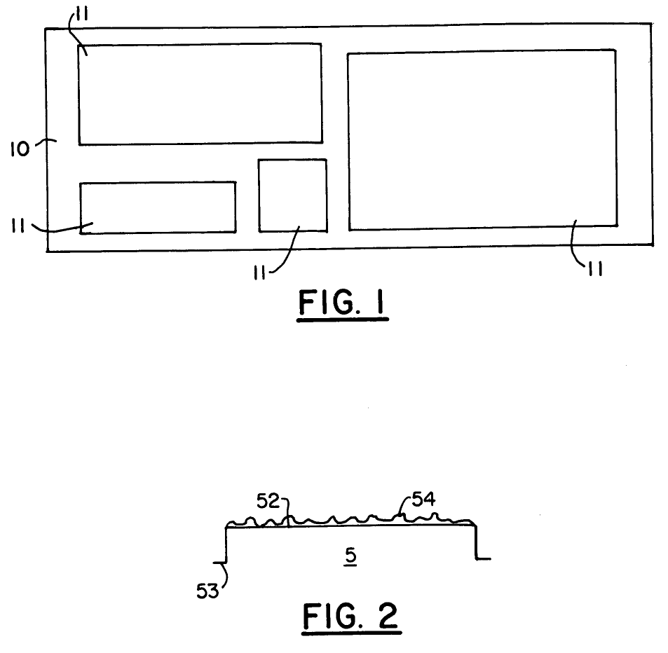

FIG. 1 depicts a top view of a standard siding panel, manufactured in accordance with the present invention. The panel 1 is preferably sized in conformity with standard construction siding dimensions. The nominal thickness of the panel 1 is approximately ⅛ inch. It should be noted that other thicknesses are permitted within the scope of the present invention, as are all of the overall dimensions of panel 1.

Panel 1 is essentially a template layer 10, defining a grout pattern formed around apertures or open spaces 11. The configuration of apertures or open spaces 11 can be any that a designer would use to simulate a pattern of natural materials such as brick or stone. In the preferred embodiment depicted in FIG. 1, rectangular stones are simulated. The grout pattern of template layer 10 is irregular, also simulating the mortar that would be used with natural stones of various sizes.

It should be understood that while rectangular apertures or open spaces 11 are used in the preferred embodiment, rectangular apertures are not necessary for the concept of the present invention. Rather, almost any size or shape of aperture can be used to simulate a structure made of natural building materials such as stone or brick.

In the preferred embodiment, the open spaces or apertures 11 are filled with protrusions 5 of simulated stone as depicted in FIG. 2. Each of these protrusions 5 is constituted by an upper wall 52 having a contoured surface 54. The upper wall is supported by four side walls 51 to form a continuous structure. Each of the sidewalls has a continuous flange 53. This flange 53 is configured to fit beneath the grout pattern of template layer 10 and be held thereto by conventional techniques. Examples include, but are not limited to, adhesive, chemical bonding, sonic welding, heat welding, or even external connectors (not shown).

The upper wall 52 can have almost any kind of contoured surface 54 applied thereto. Further, the contoured surface can be formed as a part of upper wall 52. In many instances, such as that of injection plastic molding, this is preferred technique. The overall thickness of the sidewall and flanges is approximately the same as that of the grout pattern of template layer 10. However, because the two panel parts 10, 5 are formed separately, differences in thickness, as well as color and texture, are easily facilitated. Simulated stone protrusion 5 preferably extends in the range of ½ inch to 6 inches above the grout border or template layer 10. However, the invention is not confined to these dimensional limits.

A key esthetic feature of the present invention is that grout, as represented by the grout pattern of template layer 10 is almost always a much lighter (or darker) color than the stone or brick which the grout surrounds. Traditionally, this was accomplished only by a difficult (expensive), post-molding painting processes. This is in contrast with the present invention in which the simulated stone of protruding pieces 5 can be formed of virtually any color or texture while the grout pattern of template layer 10 is separately formed of a much lighter (or darker) colored material. Since both template layer 10 and the simulated stone protrusions 5 of panel 1 are formed separately, the coloring can be added as part of the plastic batch selected for each piece. This makes the overall process much less expensive and much easier to facilitate.

Further, because plastic injection molding is being used, mass production is facilitated even for a wide variety of different stone sizes, contours and colors. This facilitates the use of multi-piece kits with a wide variety of extra simulated stone pieces 5 to achieve variety.

While plastic injection molding is the preferred method of manufacture of both elements (grout panel 10 and simulation stone protrusion 5) of panel 1, plastic injection molding is not a requirement within the concept of the present invention. Rather, any combination of manufacturing processes can be used. For example, very irregular shapes can be put into wooden molds and a pour made for individual simulated stone pieces 5. The individual simulated stone protrusions can then be fit into the enclosed openings in a suitable grout pattern of a template layer 10. Further, the simulated stone need not be of the same material used for the grout pattern 10. Rather, foam or thin plaster can be formed in the appropriate shape (for stone protrusion 5) and can be used in a complementary opening 11, in the grout pattern of template layer 10.

The grout pattern of template layer 10, which is formed in its entirety with panel 1, is only one example of how the panel and grout pattern can be formed. If need be, the grout pattern 10 can be formed of individual strips or pieces bonded together in a pattern of enclosed openings 11, in virtually any shape desired. The strips can be connected together by adhesive, chemical welding, sonic welding or thermal welding, or even through the use of external connectors (not shown). Also, an existing grout pattern 10 can be reconfigured simply by cutting parts of it.

Because the grout pattern of template layer 10 of the overall panel 1, and the simulated stones 5 are formed separately, the weight of the overall panel is reduced for purposes of handling and transport, even if thicker configurations and denser materials are used. Ease of handling is crucial, especially on a construction site. This facilitates the assembly of panels 1 with unskilled labor. Further, the selection of colors and textures for individual stone protrusions 5 can be made at the time of installation, thereby granting far greater latitude for esthetic considerations. Kits of standard sizes, shapes and textures, with many variations become practical.

Because light, inexpensive molded plastic is the preferred material for the present invention, the use of kits with multiple, additional panels 1 having different grout configurations 10 becomes practical. A wide variety of different simulated stone protrusions 5 can be included in a kit so that the final installer can make the selection for the desired esthetic effect on the structure. This wide variety of different choices is achieved with very little additional expense, and is one of the benefits of the present invention. Likewise, the concept of the present invention admits to a wide variety of different materials, configurations, patterns or thicknesses. This includes the use of a plastic material that can hold a foam backing for insulation. Because the size of the panels can be altered in accordance with the structure that will receive the panels, the panels can be cut down in size to accommodate much heavier and/or thicker materials.

It should be understood that virtually any material that can be used as a siding panel for a structure, can also be used within the concept of the present invention. Consequently, the present invention is not limited to injection molded plastic in the ⅛ inch thickness range, even though this is one preferred embodiment. Conceivably, the same concept can be applied to foam, nylon, neoprene, metals (such as aluminum), plaster, and virtually any kind of plastic material.

Thus, while the present invention has been described by way of example, the present invention is not limited thereto. Rather, the present invention should be construed to include any and all variations, modifications, adaptations, derivations, and embodiments that would occur to one skilled in this art once in possession of the teachings of the present invention. Consequently, the present invention should be interpreted to be limited only by the following claims.

I claim:

1. A siding system having at least one panel, each said panel comprising:
a) a template layer having at least one aperture surrounded by a border; and
b) at least one separate, attachable, protruding piece configured to fit into said at least one aperture, and extending above said template layer.

2. The siding system of claim 1, wherein each said protruding piece comprises as flange, a side wall and a raised portion supported by said side wall.

3. The siding system of claim 2, wherein said raised portion is textured to simulate a natural building material.

4. The siding system of claim 1, wherein said template layer comprises a plurality of apertures.

5. The siding system of claim 4, wherein said template layer further comprises a contiguous surround of all said apertures.

6. The siding system of claim 2, further comprising means for connecting said flanges to said template layer.

7. The siding system of claim 1, wherein said template layer and said protruding pieces comprise plastic.

8. The siding system of claim 7, wherein said plastic is different for said template layer and said protruding pieces.

9. The siding system of claim 1, wherein said apertures are selected from a group of standard sizes.

10. The siding system of claim 9, wherein said protruding pieces are selected from a group of standard sizes, textures, and colors.

11. The siding system of claim 10, wherein said template layer is configured to fit a specific size and shape of a mounting substrate.

12. The siding system of claim 7, wherein said plastic is ⅛ inch thick.
